(19) United States
(12) Patent Application Publication
(10) Pub. No.: US 2025/0210763 A1
(43) Pub. Date: Jun. 26, 2025

(54) CYLINDRICAL BATTERY

(71) Applicant: Panasonic Energy Co., Ltd., Osaka (JP)

(72) Inventor: Yohei FURUTA, Osaka (JP)

(21) Appl. No.: 18/848,757

(22) PCT Filed: Mar. 20, 2023
(86) PCT No.: PCT/JP2023/010791

§ 371 Date: Sep. 19, 2024

(30) Foreign Application Priority Data
Mar. 30, 2022 (JP) 2022-055049

(51) Int. Cl. H01M 50/167; H01M 10/0587; H01M 50/107; H01M 50/184

(52) U.S. Cl. CPC H01M 50/167; H01M 10/0587; H01M 50/107; H01M 50/184

(57) ABSTRACT

A cylindrical battery includes: an electrode body in which a positive electrode and a negative electrode are wound with a separator therebetween; a bottomed cylindrical external can that accommodates the electrode body; and a sealing body that is fixed by staking at an opening portion of the external can via a gasket. The external can includes an annular shoulder portion that presses the gasket in the axial direction. A plurality of grooves that are positioned at intervals in the circumferential direction and extend in substantially radial directions are provided on the inner surface of the shoulder portion.

### TECHNICAL FIELD

The present disclosure relates to a cylindrical battery.

### BACKGROUND ART

As a conventional cylindrical battery, there is a cylindrical battery described in Patent Literature 1. The cylindrical battery includes a gasket disposed between an external can and a sealing assembly. The sealing assembly is fixed by crimping to an opening portion of the external can via the gasket. The external can comprises a shoulder, a grooved portion, a cylinder-shaped portion, and a bottom. The shoulder is formed such that in fixing the sealing assembly to the external can by crimping, an upper end of the external can is inwardly folded toward a circumferential edge of the sealing assembly. In the cylindrical battery, a plurality of notches leading to an inner side end is provided in the shoulder of the external can to suppress waving of the external can at the time of crimping.

### CITATION LIST

### Patent Literature

PATENT LITERATURE 1: Japanese Unexamined Patent Application Publication No. 2012-234716

### SUMMARY

The inventor of the present invention has confirmed that when the hardness of an external can is high, a scratch is generated in a shoulder of the external can at the time of crimping in some cases. Therefore, it is an advantage of the present disclosure to provide a cylindrical battery that is less likely to generate a scratch in the shoulder of the external can and that is also excellent in a sealing property.

To solve the aforementioned problem, the cylindrical battery according to the present disclosure comprises: an electrode assembly in which a positive electrode and a negative electrode are wound with a separator therebetween; a bottomed cylinder-shaped external can that accommodates the electrode assembly; and a sealing assembly that is fixed by crimping at an opening portion of the external can via a gasket, in which the external can includes an annular shoulder that presses the gasket in an axial direction, and a plurality of grooves is provided on an inner surface of the shoulder, the plurality of grooves being positioned at intervals in a circumferential direction and extending in a substantially radial direction.

The grooves may extend in a direction slightly inclined relative to the radial direction, and may extend, for example, in a direction inclined relative to the radial direction by an angle of less than or equal to two degrees.

According to the cylindrical battery according to the present disclosure, a scratch is less likely to be generated in the shoulder of the external can and an excellent sealing property may also be achieved.

### BRIEF DESCRIPTION OF DRAWINGS

FIG. 1 is a sectional view in an axial direction of a cylindrical battery according to one embodiment of the present disclosure.

FIG. 2 is a perspective view of an electrode assembly of the aforementioned cylindrical battery.

FIG. 3 is an expanded sectional view of the surrounding of a shoulder of an external can of FIG. 1.

FIG. 4 is a perspective view showing an opening side of the external can before crimping.

FIG. 5 is an enlarged perspective view of a region R shown in FIG. 4.

FIG. 6 is a perspective view showing a method for forming grooves of the present disclosure.

### DESCRIPTION OF EMBODIMENTS

Hereinafter, with reference to the drawings, an embodiment of a cylindrical battery according to the present disclosure will be described in detail. Note that the cylindrical battery of the present disclosure may be a primary battery or a secondary battery. Further, the cylindrical battery of the present disclosure may be a battery using an aqueous electrolyte or a battery using a non-aqueous electrolyte. Hereinafter, as a cylindrical battery 10 as one embodiment, a non-aqueous electrolyte secondary battery (lithium ion battery) using a non-aqueous electrolyte will be illustrated, but the cylindrical battery of the present disclosure is not limited thereto.

It has been initially expected that the characteristics of the embodiment and modification described below are appropriately combined to form a new embodiment. In the embodiment below, the same components in the drawings will be assigned the same reference signs and the overlapping descriptions will be omitted. Further, a plurality of drawings includes schematic illustrations, and among the different drawings, the dimensional ratios in length, width, height, and the like of each member do not necessarily correspond. In the present specification, the side of a sealing assembly 17 in the axial direction (height direction) of the cylindrical battery 10 is assumed to be “up” and the side of a bottom 55 of an external can 16 in the axial direction is assumed to be “down.”

Further, of the constituent elements described below, the constituent elements that are not recited in independent claim showing the most generic concept are optional constituent elements, and not essential constituent elements.

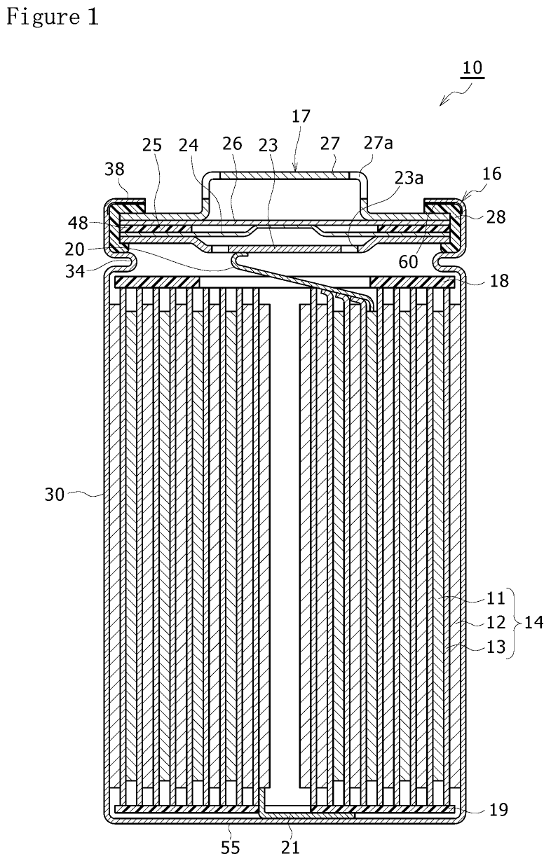

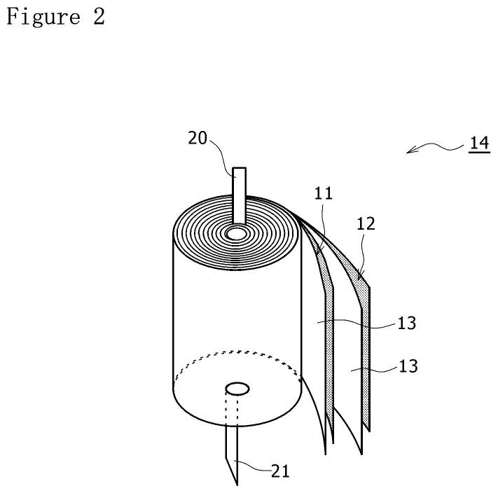

FIG. 1 is a sectional view in the axial direction of the cylindrical battery 10 according to one embodiment of the present disclosure, and FIG. 2 is a perspective view of an electrode assembly 14 of the cylindrical battery 10. As shown in FIG. 1, the cylindrical battery 10 comprises the wound-type electrode assembly 14, a non-aqueous electrolyte (not shown), a bottomed cylinder-shaped metal external can 16 that accommodates the electrode assembly 14 and the non-aqueous electrolyte, and the sealing assembly 17 that seals an opening portion of the external can 16. As shown in FIG. 2, the electrode assembly 14 has a wound structure in which a long positive electrode 11 and a long negative electrode 12 are wound with two long separators 13.

The negative electrode 12 is formed in dimensions slightly larger than the positive electrode 11 in order to prevent lithium deposition. In other words, the negative electrode 12 is formed longer in the longitudinal direction and in the width direction (lateral direction) than the positive electrode 11. Further, the two separators 13 are formed in dimensions slightly larger than at least the positive electrode 11 and are disposed, for example, so as to sandwich the positive electrode 11. As shown in FIG. 1, the negative electrode 12 may form a winding-start end of the electrode assembly 14. Alternatively, the separator 13 may extend beyond an end on a winding-start side of the negative electrode 12 to form the winding-start end of the electrode assembly 14.

The non-aqueous electrolyte includes a non-aqueous solvent and electrolyte salt dissolved in the non-aqueous solvent. For the non-aqueous solvent, for example, esters, ethers, nitriles, amides, and any mixed solvent of two or more thereof may be used. The non-aqueous solvent may contain a halogen-substituted product formed by replacing at least a portion of a hydrogen atom of any of these solvents with a halogen atom such as fluorine. Note that the non-aqueous electrolyte is not limited to a liquid electrolyte and may be a solid electrolyte using a gel polymer or the like. For the electrolyte salt, lithium salt such as LiPF₆ is used.

The positive electrode 11 includes a positive electrode core and positive electrode mixture layers formed on both sides of the positive electrode core. For the positive electrode core, metal foil stable in a potential range of the positive electrode 11, such as aluminum and an aluminum alloy, a film with the metal disposed on the surface layer, and the like can be used. The positive electrode mixture layers include a positive electrode active material, a conductive agent, and a binding agent. The positive electrode 11 can be produced, for example, such that the positive electrode core is coated with positive electrode mixture slurry including the positive electrode active material, the conductive agent, the binding agent, and the like, and the coating is dried and is then compressed so that the positive electrode mixture layers are formed on both sides of the positive electrode core.

The positive electrode active material includes a lithium-containing metal complex oxide as a main component. Examples of the metal element contained in the lithium-containing metal complex oxide may include Ni, Co, Mn, Al, B, Mg, Ti, V, Cr, Fe, Cu, Zn, Ga, Sr, Zr, Nb, In, Sn, Ta, and W. A preferable example of the lithium-containing metal complex oxide is a complex oxide containing at least one of the group consisting of Ni, Co, Mn, and Al.

Examples of the conductive agent included in the positive electrode mixture layer may include a carbon material, such as carbon black, acetylene black, ketjen black, and graphite. Examples of the binding agent included in the positive electrode mixture layer may include a fluorocarbon resin, such as polytetrafluoroethylene (PTFE) and polyvinylidene fluoride (PVdF), polyacrylonitrile (PAN), a polyimide resin, an acrylic resin, and a polyolefin resin. These resins and carboxymethylcellulose (CMC) or a cellulose derivative such as carboxymethylcellulose salt, a polyethylene oxide (PEO), and the like may be concurrently used.

The negative electrode 12 includes a negative electrode core and negative electrode mixture layers formed on both sides of the negative electrode core. For the negative electrode core, metal foil stable in a potential range of the negative electrode 12, such as copper and a copper alloy, a film with the metal disposed on the surface layer, and the like can be used. The negative electrode mixture layers include a negative electrode active material and a binding agent. The negative electrode 12 can be produced, for example, such that the negative electrode core is coated with negative electrode mixture slurry including the negative electrode active material, the binding agent, and the like, and the coating is dried and is then compressed so that the negative electrode mixture layers are formed on both sides of the negative electrode core.

For the negative electrode active material, a carbon material that reversibly occludes and releases lithium ions is generally used. The preferable carbon material is graphite, such as natural graphite such as flake graphite, massive graphite, and amorphous graphite, artificial graphite such as massive artificial graphite and graphitized mesophase carbon microbeads. The negative electrode mixture layer may include, as the negative electrode active material, a Si material-containing silicon (Si). In addition, for the negative electrode active material, metal to be alloyed with lithium other than Si, an alloy containing the metal, a compound containing the metal, and the like may be used.

For the binding agent included in the negative electrode mixture layer, a fluorocarbon resin, PAN, a polyimide resin, an acrylic resin, a polyolefin resin, and the like may be used, as with the case of the positive electrode 11, but styrene butadiene rubber (SBR) or a modified product thereof is preferably used. For the negative electrode mixture layer, for example, in addition to SBR or the like, CMC or CMC salt, polyacrylic acid (PAA) or polyacrylic acid salt, and polyvinyl alcohol may be included.

For the separator 13, a porous sheet having ion permeability and insulating property is used. Specific examples of the porous sheet may include a microporous thin film, cloth, and a nonwoven fabric. As a material of the separator 13, a polyolefin resin such as polyethylene and polypropylene, cellulose, and the like are preferable. The separator 13 may be in either a single layer structure or a stacked layer structure. On the surface of the separator 13, a heat-resistant layer and the like may be formed.

As shown in FIG. 1, a positive electrode lead 20 is joined to the positive electrode 11 and a negative electrode lead 21 is joined to the winding-start side in the longitudinal direction of the negative electrode 12. The cylindrical battery 10 includes an insulating plate 18 on an upper side of the electrode assembly 14 and an insulating plate 19 on a lower side of the electrode assembly 14. The positive electrode lead 20 passes through a through-hole of the insulating plate 18 and extends to the sealing assembly 17 side, and the negative electrode lead 21 passes through a through-hole of the insulating plate 19 and extends to the bottom 55 side of the external can 16. The positive electrode lead 20 is connected to an underside of a bottom plate 23 of the sealing assembly 17 by welding or the like. A terminal cap 27 forming a top plate of the sealing assembly 17 is electrically connected to the bottom plate 23 and the terminal cap 27 serves as a positive electrode terminal. Further, the negative electrode lead 21 is connected to an inner surface of the bottom 55 of the metal external can 16 by welding or the like and the external can 16 serves as a negative electrode terminal.

In the example shown in FIG. 1 and FIG. 2, the positive electrode lead 20 is electrically connected to a middle section such as a center in a winding direction of the positive electrode core, and the negative electrode lead 21 is electrically connected to an end on the winding-start side in a winding direction of the negative electrode core. Further, on an outermost circumferential surface of the electrode assembly 14, the negative electrode core is exposed contacting an inner surface of the external can 16. However, the negative electrode lead may be electrically connected to an end on a winding-end side in the winding direction of the negative electrode core. Alternatively, the electrode assembly may include two negative electrode leads, with one negative electrode lead electrically connected to the end on the winding-start side in the winding direction of the negative electrode core and with the other negative electrode lead electrically connected to the end on the winding-end side in the winding direction of the negative electrode core. As shown in FIG. 1, when the negative electrode core contacts the inner surface of the external can, the negative electrode lead 21 may be omitted.

The cylindrical battery 10 further comprises a resin gasket 28 disposed between the external can 16 and the sealing assembly 17. The sealing assembly 17 is fixed by crimping at the opening portion of the external can 16 via the gasket 28. In this manner, an interior space of the cylindrical battery 10 is sealed. The gasket 28 is sandwiched between the external can 16 and the sealing assembly 17 and insulates the sealing assembly 17 from the external can 16. The gasket 28 has a function as a sealing material to maintain the air tightness inside the battery and a function as an insulating material to insulate between the external can 16 and the sealing assembly 17.

The external can 16 accommodates the electrode assembly 14 and the non-aqueous electrolyte and includes a shoulder 38, a grooved portion 34, a cylinder-shaped portion 30, and the bottom 55. The grooved portion 34 can be formed by, for example, spinning a portion of a side wall of the external can 16 radially inward so as to annularly dent the portion radially inward. The shoulder 38 is formed such that in fixing the sealing assembly 17 to the external can 16 by crimping, an upper end of the external can 16 is inwardly folded toward a circumferential edge 48 of the sealing assembly 17.

The sealing assembly 17 has a structure in which the bottom plate 23, a lower vent member 24, an insulating member 25, an upper vent member 26, and the terminal cap 27 are stacked in this order from the electrode assembly 14 side. The members forming the sealing assembly 17 have, for example, a disc-shape or a ring-shape, and are electrically connected to one another, except for the insulating member 25. The bottom plate 23 includes at least one through-hole 23a. Further, the lower vent member 24 and the upper vent member 26 are connected at the respective centers and the insulating member 25 is interposed between the respective circumferential edges.

When the cylindrical battery 10 abnormally generates heat to increase the internal pressure of the cylindrical battery 10, the lower vent member 24 is deformed so as to push up the upper vent member 26 toward the terminal cap 27 and breaks, so that the current path between the lower vent member 24 and the upper vent member 26 is disrupted. When the internal pressure further increases, the upper vent member 26 breaks, thereby discharging gas through a through-hole 27a of the terminal cap 27. By discharging the gas, the cylindrical battery 10 can be prevented from rupturing due to an excessive increase in the internal pressure of the cylindrical battery 10, thereby being able to improve the safety of the cylindrical battery 10.

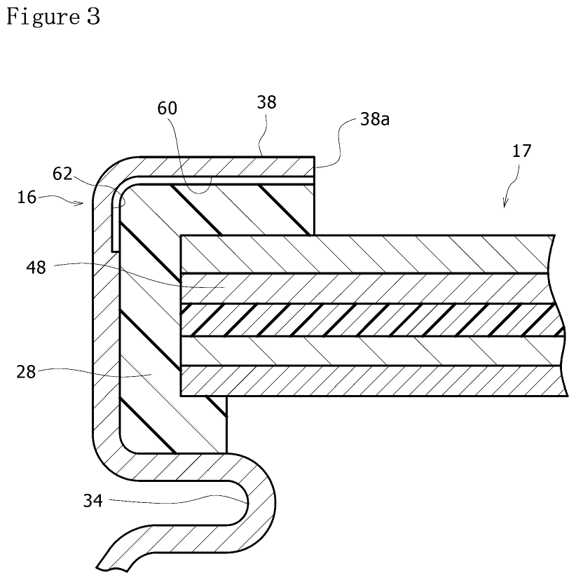

FIG. 3 is an expanded sectional view of the surrounding of the shoulder 38 of the external can 16 of FIG. 1. As shown in FIG. 3, a plurality of grooves 60 is provided on an inner surface of the opening portion of the external can 16 (end portion on an opening side of the external can 16). The plurality of grooves 60 is provided at intervals in a circumferential direction, and is substantially equidistantly provided in the circumferential direction in the example shown in FIG. 3. The grooves 60 are provided on an inner surface of the shoulder 38 and extend to an inner side end 38a in a radial direction of the shoulder 38. The inner side end 38a in the radial direction of the shoulder 38 corresponds to an opening end of the external can 16. A portion of the grooves 60 may be positioned on an inner circumferential surface 62 of the external can 16. The groove width of the grooves 60 increases toward the inner side end 38a. The grooves 60 have a substantially constant depth. The depth of the grooves 60 is, for example, greater than or equal to 10% and less than or equal to 30% of the thickness of the external can 16. Further, the average groove width of the grooves 60 is greater than or equal to 0.03% and less than or equal to 0.06% of the circumferential length of the external can before crimping.

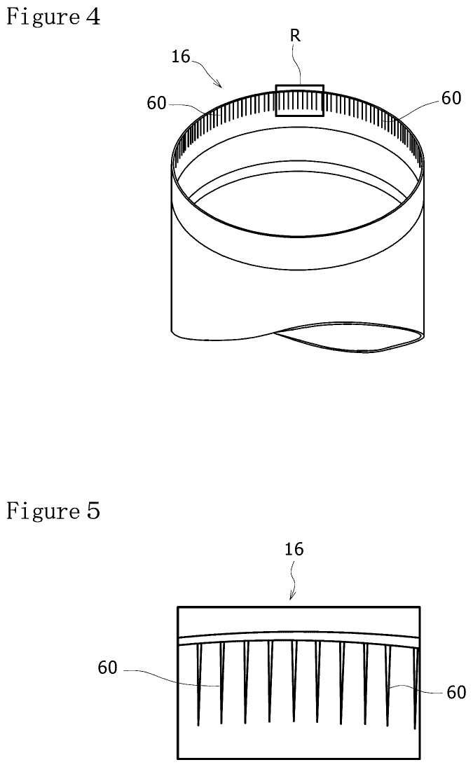

FIG. 4 is a perspective view showing the opening side of the external can 16 before crimping, and FIG. 5 is an enlarged perspective view of a region R shown in FIG. 4. As shown in FIG. 4, the external can 16 has a substantially cylindrical shape. The external can 16 includes the plurality of grooves 60 extending in the axial direction (height direction) on the inner surface. The plurality of grooves 60 is substantially equidistantly provided in the circumferential direction. The grooves 60 extend to the opening end in the axial direction. As shown in FIG. 5, the groove width of the grooves 60 increases toward the opening end side.

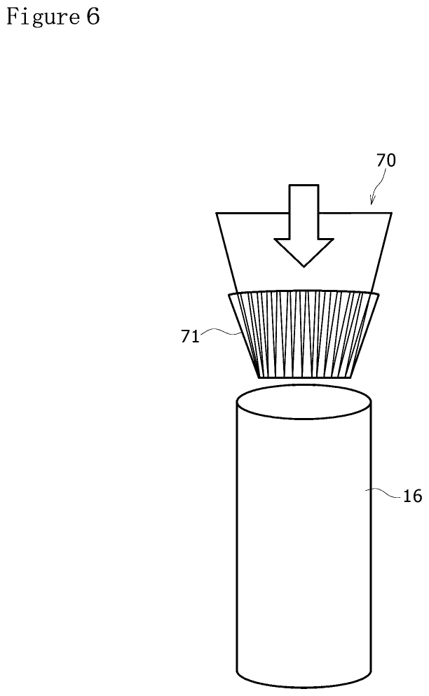

The plurality of grooves 60 can be formed, for example, using a mold 70 shown in FIG. 6. More specifically, the mold 70 includes, on an outer circumferential surface, a plurality of projections 71 corresponding to the plurality of grooves 60. By press-fitting the mold 70 to the inner side of the opening portion of the cylindrical external can 16 before crimping and taking in and out the mold 70 in the axial direction, the plurality of grooves 60 can be formed on the inner side of the opening portion of the external can 16 before crimping. Note that the plurality of grooves 60 may be formed using any method, and may be formed by, for example, etching or cutting. The plurality of grooves 60 is formed in the external can 16 before crimping along the axial direction so as to include a position corresponding to the shoulder 38.

Next, the function and effect of providing the plurality of grooves on the inner side of the opening portion of the external can 16 before crimping will be described. The circumferential length of the shoulder 38, which is formed by inwardly folding the opening side of the external can 16 toward the circumferential edge 48 of the sealing assembly 17 at the time of crimping, is reduced toward a distal end of the shoulder 38. Therefore, at the time of crimping of the external can 16, the shoulder 38 receives a compression load in the circumferential direction, and the compression load increases toward the distal end side of the shoulder 38.

However, according to the technique of the present disclosure, the grooves 60 extending in the axial direction are provided on the opening side of the external can 16 before crimping. Therefore, at the time of crimping, a part of a thick portion of the shoulder 38 receiving the compression load can be released to the grooves 60. Therefore, the compression load in the circumferential direction that the shoulder 38 receives at the time of crimping can be mitigated to thus be able to suppress generation of a scratch in the shoulder 38.

Further, since the grooves 60 extend to the inner side end 38a of the shoulder 38, a part of the thick portion at a site in the radial direction where the circumferential length is shortest due to crimping can be surely released to the grooves 60. Therefore, the compression load in the circumferential direction that the shoulder 38 receives can be effectively mitigated, so that generation of a scratch in the shoulder 38 can be effectively suppressed. Further, since the width of the grooves 60 increases toward the inner side end 38a of the shoulder 38, the compression load in the circumferential direction that the shoulder 38 receives can be effectively mitigated, so that generation of a scratch in the shoulder 38 can be effectively suppressed.

According to the technique of the present disclosure, as compared to a case in which slit-like notches are provided in the shoulder of the external can, the mechanical strength of the shoulder 38 of the external can 16 can be secured, thereby being able to also achieve an excellent sealing property of the cylindrical battery 10.

When the grooves 60 have a depth greater than or equal to 10% of the thickness of the external can 16, a part of the thick portion can be surely released to the grooves 60 at the time of crimping, so that generation of a scratch can be effectively suppressed. When the grooves 60 have a depth less than or equal to 30% of the thickness of the external can 16, the rigidity of the shoulder 38 can be made sufficiently large to thus be able to achieve an excellent sealing property. When the average groove width of the grooves 60 is greater than or equal to 0.03% of the circumferential length of the external can 16, a part of the thick portion can be surely released to the grooves 60 at the time of crimping, so that generation of a scratch can be effectively suppressed. When the average groove width of the grooves 60 is less than or equal to 0.06% of the circumferential length of the opening end 38a of the external can 16, the rigidity of the shoulder 38 can be made sufficiently large to thus be able to achieve an excellent sealing property.

Note that the present disclosure is not limited to the aforementioned embodiment and a modification thereof, and various improvements and changes are available within the matters described in the scope of claims of the present application and the equivalents. For example, in the aforementioned embodiment, the case in which a portion of the grooves 60 is positioned on the inner circumferential surface of the external can 16 has been described, but the grooves may be formed only on the inner surface of the shoulder 38. Further, the case in which the grooves 60 extend to the inner side end 38a of the shoulder 38 has been described, but the grooves may not extend to the inner side end of the shoulder. Furthermore, the case in which the groove width of the grooves 60 increases toward the distal end has been described, but the groove width may be substantially constant. In addition, the case in which the depth of the grooves 60 is substantially constant has been described, but the depth of the groove 60 may not be constant, and may increase toward the inner side end of the shoulder, for example. Further, the grooves may extend in a direction slightly inclined relative to the radial direction.

### REFERENCE SIGNS LIST

10 Cylindrical battery, 11 Positive electrode, 12 Negative electrode, 13 Separator, 14 Electrode assembly, 16 External can, 17 Sealing assembly, 18, 19 Insulating plate, 20 Positive electrode lead, 21 Negative electrode lead, 23 Bottom plate, 23a Through-hole, 24 Lower vent member, 25 Insulating member, 26 Upper vent member, 27 Terminal cap, 27a Through-hole, 28 Gasket, 30 Cylinder-shaped portion, 34 Grooved portion, 38 Shoulder, 38a Inner side end, 48 Circumferential edge, 55 Bottom, 60 Groove, 62 Inner circumferential surface, 70 Mold, 71 Projection of mold

1. A cylindrical battery comprising:
an electrode assembly in which a positive electrode and a negative electrode are wound with a separator therebetween;
a bottomed cylinder-shaped external can that accommodates the electrode assembly; and
a sealing assembly that is fixed by crimping at an opening portion of the external can via a gasket, wherein
the external can includes an annular shoulder that presses the gasket in an axial direction, and
a plurality of grooves is provided on an inner surface of the shoulder, the plurality of grooves being positioned at intervals in a circumferential direction and extending in a substantially radial direction.

2. The cylindrical battery according to claim 1, wherein the grooves extend to an inner side end in the radial direction of the shoulder.

3. The cylindrical battery according to claim 1, wherein a width of the grooves increases toward an inner side in the radial direction.
